(19) United States
(12) Patent Application Publication
(10) Pub. No.: US 2012/0308819 A1
(43) Pub. Date: Dec. 6, 2012

(54) FIRE-RETARDANT COPOLYETHERESTER COMPOSITION AND ARTICLES COMPRISING THE SAME

(75) Inventor: YONG NI, Shanghai (CN)

(73) Assignee: E I DU PONT DE NEMOURS AND COMPANY, Wilmington, DE (US)

(21) Appl. No.: 13/464,192

(22) Filed: May 4, 2012

(30) Foreign Application Priority Data
May 30, 2011 (CN) 201110157903.7

(51) Int. Cl. C08K 5/3492; B32B 27/02

(52) U.S. Cl. 428/383; 524/101; 428/389

(57) ABSTRACT

Disclosed herein is a fire-retardant copolyetherester composition comprising: (a) at least one copolyetherester; (b) about 5-30 wt. % of at least one halogen-free flame retardant; (c) about 0.1-20 wt. % of at least one nitrogen-containing compound; and (d) about 0.01-5 wt. % of at least one molybdenum oxide. Further disclosed herein are articles comprising component parts formed of the fire-retardant copolyetherester composition.

### CROSS-REFERENCE TO RELATED APPLICATION

This application claims priority from China National Patent Application No. 201110157903.7, filed on May 30, 2011, which is incorporated herein by reference in its entirety.

### TECHNICAL FIELD

The disclosure is related to fire-retardant copolyetherester compositions with good thermal stability and articles comprising the same.

### BACKGROUND

Due to its excellent mechanical properties (e.g., tear strength, tensile strength, flex life, and abrasion resistance), polymeric compositions based on copolyetherester elastomers have been used in forming components for motorized vehicles and electrical/electronic devices. However, often times, electric arc may be formed and high temperature may be reached within the under-hood areas of vehicles and inside electrical/electronic devices. Thus, while maintaining other mechanical properties, it is desirable that such copolyetherester based compositions also have low flammability and high thermal stability.

Various flame retardant systems have been developed and used in polymeric material, e.g., polyesters, to improve the fire-resistance thereof. However, due to toxicity concerns, halogen-free flame retardants are gaining more and more attention. Among the various halogen-free flame retardants, phosphorus compounds (such as salts of phosphinic or diphosphinic acids) are used the most due to the stability and flame retardant effectiveness thereof. Prior art has also demonstrated that various types of synergistic compounds can be used in combination with the phosphorus compounds to further maximize the flame retardant effectiveness thereof. For example, U.S. Pat. No. 6,547,992 discloses the use of synthetic inorganic compounds such as oxygen compounds of silicon, magnesium compounds, metal carbonates of metals of the second main group of the periodic table, red phosphorus, zinc compounds, aluminum compounds, or combinations thereof as flame retardant synergists; U.S. Pat. No. 6,716,899 discloses the use of organic phosphorus-containing compounds as flame retardant synergists; U.S. Pat. No. 6,365,071 discloses the use of nitrogen-containing compounds (e.g., melamine cyanurate, melamine phosphate, melamine pyrophosphate, or melamine diborate) as flame retardant synergists; and U.S. Pat. No. 6,255,371 discloses the use of reaction products of phosphoric acids with melamine or condensed products of melamine (e.g., melamine polyphosphate (MPP)) as flame retardant synergists. Moreover, U.S. Patent Publication No. 2008/0039571 discloses the use of metal hydroxides (e.g., magnesium hydroxide, aluminum hydroxide), antimony compounds (e.g., antimony trioxide, sodium antimonate, antimony pentoxide, etc.), boron compounds (e.g., zinc borate, boric acid, borax, etc.), phosphorous compounds (e.g., organic phosphate esters, phosphates, halogenated phosphorus compounds, inorganic phosphorus containing salts, etc.), or other metal compounds (e.g., molybdenum compounds, molybdenum trioxide, ammonium octamolybdate (AOM), zirconium compounds, titanium compounds, zinc stannate, zinc hydroxyl stannates, etc.) as primary flame retardants or flame retardant synergists.

Particularly, European Patent Publication No. EP1883081 and PCT Patent Publication Nos. WO2009/047353 and WO2010/094560 each disclose flame retardant elastomeric compositions useful in forming the insulating layers and/or jackets of wires and cables. In those disclosures, combinations of (i) a metal salt of a phosphinic acid and/or a diphosphinic acid, (ii) a nitrogen containing compound (e.g., melamine polyphosphate), and (iii) an inorganic compound (e.g., zinc borate) are taught as preferred flame retardant packages. It has been known in the art that the addition of high levels of additives, such as inorganic compounds, in polymer compositions could cause deterioration of certain properties. The above references also teach that, by the use of such preferred flame retardant packages, one can effectively lower the total amount of flame retardants and/or synergists needed in the composition and therefore minimize the negative impact on other properties. However, as demonstrated in the examples below, the present Applicant discovered that when such prior art flame retardant packages are used in copolyetherester compositions, the thermal stability thereof is very poor. Therefore, a need to develop a copolyetherester composition having both good fire-resistance and good thermal stability still exists.

### SUMMARY

The purpose of the present disclosure is to provide a fire-retardant copolyetherester composition having improved thermal stability, which comprises: (a) 45-94.89 wt. % at least one copolyetherester; (b) 5-30 wt. % of at least one halogen-free flame retardant; (c) 0.1-20 wt. % of at least one nitrogen-containing compound; and (d) 0.01-5 wt. % of at least one molybdenum oxide, the percentages being abased on the combined weight of (a) plus (b) plus (c) plus (d) and wherein the at least one halogen-free flame retardant comprises at least one selected from the group consisting of phosphinates of the formula (I), diphosphinates of the formula (II), and combinations or polymers thereof

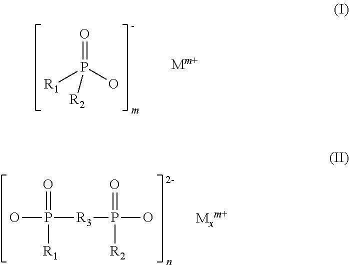

wherein R₁ and R₂ are identical or different and each of R₁ and R₂ is hydrogen; a linear, branched, or cyclic C₁-C₆ alkyl group; or a C₆-C₁₀ aryl group; R₃ is a linear or branched C₁-C₁₀ alkylene group, a C₆-C₁₀ arylene group, a C₆-C₁₂ alkyl-arylene group, or a C₆-C₁₂ aryl-alkylene group; M is selected from the group consisting of calcium ions, aluminum ions, magnesium ions, zinc ions, antimony ions, tin ions, germanium ions, titanium ions, iron ions, zirconium ions, cerium ions, bismuth ions, strontium ions, manganese ions, lithium ions, sodium ions, potassium ions, and combinations of two or more thereof; and m, n, and x each is independently an integer of 1-4.

In one embodiment of the fire-retardant copolyetherester composition, the at least one molybdenum oxide is selected from the group consisting of molybdenum (IV) oxide, molybdenum (V) oxide, molybdenum (VI) oxide, and combinations thereof, and wherein the at least one molybdenum oxide is preferably molybdenum (VI) oxide.

In a further embodiment of the fire-retardant copolyetherester composition, the at least one halogen-free flame retardant is aluminum diethylphosphinate.

In a yet further embodiment of the fire-retardant copolyetherester composition, the at least one nitrogen-containing compound is selected from the group consisting of (i) melamine cyanurate, (ii) condensation products of melamine, (iii) reaction products of phosphoric acid with melamine, and (iv) reaction products of phosphoric acid with condensation products of melamine.

In a yet further embodiment of the fire-retardant copolyetherester composition, the at least one nitrogen-containing compound is melamine polyphosphate.

In a yet further embodiment of the fire-retardant copolyetherester composition, the composition comprises (a) 56-91.4 wt. % of the at least one copolyetherester; (b) 7.5-25 wt. % of the at least one halogen-free flame retardant; (c) 1-15 wt. % of the at least one nitrogen-containing compound; and (d) 0.1-4 wt. % of the at least one molybdenum oxide, the weight percentages being based on the total weight of (a), (b), (c), and (d).

In a yet further embodiment of the fire-retardant copolyetherester composition, the composition comprises, (a) 57-87.9 wt. % of the at least one copolyetherester; (b) 10-25 wt. % of the at least one halogen-free flame retardant; (c) 2-15 wt. % of the at least one nitrogen-containing compound; and (d) 0.1-3 wt. % of the at least one molybdenum oxide, the weight percentages being based on the total weight of (a), (b), (c), and (d).

The present disclosure further provides an article comprising at least one component part formed of the fire-retardant copolyetherester composition described above.

In one embodiment of the article, the article is selected from motorized vehicle parts and electrical/electronic devices.

In a further embodiment of the article, the article is selected from insulated wires and cables. And the insulated wires and cables may comprise one or more insulating layers and/or insulating jackets that are formed of the fire-retardant copolyetherester composition described above.

In accordance with the present disclosure, when a range is given with two particular end points, it is understood that the range includes any value that is within the two particular end points and any value that is equal to or about equal to any of the two end points.

### DETAILED DESCRIPTION

Disclosed herein is a fire-retardant copolyetherester composition comprising,

(a) at least one copolyetherester;

(b) about 5-30 wt. % of at least one halogen-free flame retardant;

(c) about 0.1-20 wt. % of at least one nitrogen-containing compound; and

(d) about 0.1-5 wt. % of at least one molybdenum oxide, the weight percentages being based on the total weight of (a) plus (b) plus (c) plus (d).

The copolyetheresters suitable for use in the compositions disclosed herein may be copolymers having a multiplicity of recurring long-chain ester units and recurring short-chain ester units joined head-to-tail through ester linkages, the long-chain ester units being represented by formula (I):

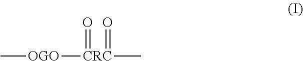

and the short-chain ester units being represented by formula (II):

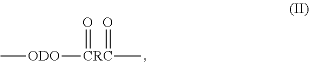

wherein,

G is a divalent radical remaining after the removal of terminal hydroxyl groups from poly(alkylene oxide)glycols having a number average molecular weight of about 400-6000;

R is a divalent radical remaining after the removal of carboxyl groups from a dicarboxylic acid having a number average molecular weight of about 300 or less;

D is a divalent radical remaining after the removal of hydroxyl groups from a glycol having a number average molecular weight of about 250 or less, and

wherein,

the at least one copolyetherester contains about 1-85 wt. % of the recurring long-chain ester units and about 15-99 wt. % of the recurring short-chain ester units.

In one embodiment, the copolyetherester used in the composition disclosed herein contains about 5-80 wt. % of the recurring long-chain ester units and about 20-95 wt. % of the recurring short-chain ester units.

In a further embodiment, the copolyetherester used in the composition disclosed herein contains about 10-75 wt. % of the recurring long-chain ester units and about 25-90 wt. % of the recurring short-chain ester units.

In a yet further embodiment, the copolyetherester used in the composition disclosed herein contains about 40-75 wt. % of the recurring long-chain ester units and about 25-60 wt. % of the recurring short-chain ester units.

As used herein, the term “long-chain ester units” refers to reaction products of a long-chain glycol with a dicarboxylic acid. Suitable long-chain glycols are poly(alkylene oxide)glycols having terminal hydroxyl groups and a number average molecular weight of about 400-6000, or about 600-3000, which include, without limitation, poly(tetramethylene oxide)glycol, poly(trimethylene oxide)glycol, poly(propylene oxide)glycol, poly(ethylene oxide)glycol, copolymer glycols of these alkylene oxides, and block copolymers such as ethylene oxide-capped poly(propylene oxide)glycol. The long-chain glycols used herein may also be combinations of two or more of the above glycols.

As used herein, the term “short-chain ester units” refers to reaction products of a low molecular weight glycol or an ester-forming derivative thereof with a dicarboxylic acid. Suitable low molecular weight glycols are those having a number average molecular weight of about 250 or lower, or about 10-250, or about 20-150, or about 50-100, which include, without limitation, aliphatic dihydroxy compounds, alicyclic dihydroxy compounds, and aromatic dihydroxy compounds (including bisphenols). In one embodiment, the low molecular weight glycol used herein is a dihydroxy compound having 2-15 carbon atoms, such as ethylene glycol; propylene glycol; isobutylene glycol; 1,4-tetramethylene glycol; pentamethylene glycol; 2,2-dimethyltrimethylene glycol; hexamethylene glycol; decamethylene glycol; dihydroxycyclohexane; cyclohexanedimethanol; resorcinol; hydroquinone; 1,5-dihydroxynaphthalene; or the like. In a further embodiment, the low molecular weight glycol used herein is a dihydroxy compound having 2-8 carbon atoms. In a yet further embodiment, the low molecular weight glycol used herein is 1,4-tetramethylene glycol. Bisphenols that are useful herein include, without limitation, bis(p-hydroxy)diphenyl, bis(p-hydroxyphenyl)methane, bis(p-hydroxyphenyl)propane, and mixtures of two or more thereof.

The ester-forming derivatives of low molecular weight glycols useful herein include those derived from the low molecular weight glycols described above, such as ester-forming derivatives of ethylene glycol (e.g., ethylene oxide or ethylene carbonate) or ester-forming derivatives of resorcinol (e.g., resorcinol diacetate). As used herein, the number average molecular weight limitations pertain to the low molecular weight glycols only. Therefore, a compound that is an ester-forming derivative of a glycol and has a number average molecular weight more than 250 can also be used herein, provided that the corresponding glycol has a number average molecular weight of about 250 or lower.

The “dicarboxylic acids” useful for reaction with the above described long-chain glycols or low molecular weight glycols are those low molecular weight (i.e., number average molecular weight of about 300 or lower, or about 10-300, or about 30-200, or about 50-100) aliphatic, alicyclic, or aromatic dicarboxylic acids.

The term “aliphatic dicarboxylic acids” used herein refers to those carboxylic acids having two carboxyl groups each attached to a saturated carbon atom. If the carbon atom to which the carboxyl group is attached is saturated and is in a ring, the acid is referred to as an “alicyclic dicarboxylic acid”. The term “aromatic dicarboxylic acids” used herein refers to those dicarboxylic acids having two carboxyl groups each attached to a carbon atom in an aromatic ring structure. It is not necessary that both functional carboxyl groups in the aromatic dicarboxylic acid be attached to the same aromatic ring. Where more than one ring is present, they can be joined by aliphatic or aromatic divalent radicals or divalent radical such as —O— or —SO₂—.

The aliphatic or alicyclic dicarboxylic acids useful herein include, without limitation, sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethyl suberic acid; cyclopentane dicarboxylic acid; decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl)carboxylic acid; 3,4-furan dicarboxylic acid; and mixtures of two or more thereof. In one embodiment, the dicarboxylic acids used herein are selected from cyclohexane dicarboxylic acids, adipic acids, and mixtures thereof.

The aromatic dicarboxylic acids useful herein include, without limitation, phthalic acids; terephthalic acids; isophthalic acids; dibenzoic acids; dicarboxylic compounds with two benzene nuclei (such as bis(p-carboxyphenyl)methane; p-oxy-1,5-naphthalene dicarboxylic acid; 2,6-naphthalene dicarboxylic acid; 2,7-naphthalene dicarboxylic acid; or 4,4′-sulfonyl dibenzoic acid); and C₁-C₁₂ alkyl and ring substitution derivatives of the aromatic dicarboxylic acids described above (such as halo, alkoxy, and aryl derivatives thereof). The aromatic dicarboxylic acids useful herein may also be, for example, hydroxyl acids such as p-(β-hydroxyethoxy)benzoic acid.

In one embodiment of the compositions disclosed herein, the dicarboxylic acids used to form the copolyetherester component may be selected from aromatic dicarboxylic acids. In a further embodiment, the dicarboxylic acids may be selected from aromatic dicarboxylic acids having about 8-16 carbon atoms. In a yet further embodiment, the dicarboxylic acids may be terephthalic acid alone or a mixture of terephthalic acid with phthalic acid and/or isophthalic acid.

In addition, the dicarboxylic acids useful herein may also include functional equivalents of dicarboxylic acids. In forming the copolyetheresters, the functional equivalents of dicarboxylic acids react with the above described long-chain and low molecular weight glycols in substantially the same way as dicarboxylic acids. Useful functional equivalents of dicarboxylic acids include ester and ester-forming derivatives of dicarboxylic acids, such as acid halides and anhydrides. As used herein, the number average molecular weight limitations pertain only to the corresponding dicarboxylic acids, not the functional equivalents thereof (such as the ester or ester-forming derivatives thereof). Therefore, a compound that is a functional equivalent of a dicarboxylic acid and has a number average molecular weight more than 300 can also be used herein, provided that the corresponding dicarboxylic acid has a number average molecular weight of about 300 or lower. Moreover, the dicarboxylic acids may also contain any substituent groups or combinations thereof that do not substantially interfere with the copolyetherester formation and the use of the copolyetherester in the compositions disclosed herein.

The long-chain glycols used in forming the copolyetherester component of the composition disclosed herein may also be mixtures of two or more long-chain glycols. Similarly, the low molecular weight glycols and dicarboxylic acids used in forming the copolyetherester component may also be mixtures of two or more low molecular weight glycols and mixtures of two or more dicarboxylic acids, respectively. In a preferred embodiment, at least about 70 mol % of the groups represented by R in Formulas (I) and (II) above are 1,4-phenylene radicals, and at least 70 mol % of the groups represented by D in Formula (II) above are 1,4-butylene radicals. When two or more dicarboxylic acids are used in forming the copolyetherester, it is preferred to use a mixture of terephthalic acid and isophthalic acid, while when two or more low molecular weight glycols are used, it is preferred to use a mixture of 1,4-tetramethylene glycol and hexamethylene glycol.

The at least one copolyetherester comprised in the fire-retardant copolyetherester composition disclosed herein may also be a blend of two or more copolyetheresters. It is not required that the copolyetheresters comprised in the blend individually meet the weight percentages requirements disclosed hereinbefore for the short-chain and long-chain ester units. However, the blend of two or more copolyetheresters must conform to the values described hereinbefore for the copolyetheresters on a weighted average basis. For example, in a blend that contains equal amounts of two copolyetheresters, one copolyetherester may contain about 10 wt. % of the short-chain ester units and the other copolyetherester may contain about 80 wt. % of the short-chain ester units for a weighted average of about 45 wt. % of the short-chain ester units in the blend.

In one embodiment, the at least one copolyetherester component comprised in the fire-retardant copolyetherester composition disclosed herein is obtained by the copolymerization of a dicarboxylic acid ester selected from esters of terephthalic acid, esters of isophthalic acid, and mixtures thereof, with a lower molecular weight glycol that is 1,4-tetramethylene glycol and a long-chain glycol that is poly(tetramethylene ether)glycol or ethylene oxide-capped polypropylene oxide glycol. In a further embodiment, the at least one copolyetherester is obtained by the copolymerization of an ester of terephthalic acid (e.g., dimethylterephthalate) with 1,4-tetramethylene glycol and poly(tetramethylene ether)glycol.

The copolyetheresters useful in the compositions disclosed herein may be made by any suitable method known to those skilled in the art, such as by using a conventional ester interchange reaction.

In one embodiment, the method involves heating a dicarboxylic acid ester (e.g., dimethylterephthalate) with a poly(alkylene oxide)glycol and a molar excess of a low molecular weight glycol (e.g., 1,4-tetramethylene glycol) in the presence of a catalyst, followed by distilling off methanol formed by the interchange reaction and continuing the heat until methanol evolution is complete. Depending on the selection of temperatures and catalyst types and the amount of the low molecular weight glycols used, the polymerization may be completed within a few minutes to a few hours and results in formation of a low molecular weight pre-polymer. Such pre-polymers can also be prepared by a number of alternate esterification or ester interchange processes, for example, by reacting a long-chain glycol with a short-chain ester homopolymer or copolymer in the presence of catalyst until randomization occurs. The short-chain ester homopolymer or copolymer can be prepared by the ester interchange either between a dimethyl ester (e.g., dimethylterephthalate) and a low molecular weight glycol (e.g, 1,4-tetramethylene glycol) as described above, or between a free acid (e.g., terephthalic acid) and a glycol acetate (e.g., 1,4-butanediol diacetate). Alternatively, the short-chain ester homopolymer or copolymer can be prepared by direct esterification from appropriate acids (e.g., terephthalic acid), anhydrides (e.g., phthalic anhydride), or acid chlorides (e.g., terephthaloyl chloride) with glycols (e.g., 1,4-tetramethylene glycol). Alternatively, the short-chain ester homopolymer or copolymer may be prepared by any other suitable process, such as the reaction of dicarboxylic acids with cyclic ethers or carbonates.

Further, the pre-polymers obtained as described above can be converted to high molecular weight copolyetheresters by the distillation of the excess low molecular weight glycols. Such process is known as “polycondensation”. Additional ester interchange occurs during the polycondensation process to increase the molecular weight and to randomize the arrangement of the copolyetherester units. In general, to obtain the best results, the polycondensation may be conducted at a pressure of less than about 1 mm Hg and a temperature of about 240-260° C., in the presence of antioxidants (such as 1,6-bis-[(3,5-di-tert-butyl-4-hydroxyphenol)propionamido]-hexane or 1,3,5-trimethyl-2,4,6-tris[3,5-di-tert-butyl-4-hydroxybenzyl]benzene), and for less than about 2 hours. In order to avoid excessive holding time at high temperatures with possible irreversible thermal degradation, it is advantageous to employ a catalyst for ester interchange reactions. A wide variety of catalysts can be used herein, which include, without limitation, organic titanates (such as tetrabutyl titanate alone or in combination with magnesium or calcium acetates), complex titanates (such as those derived from alkali or alkaline earth metal alkoxides and titanate esters), inorganic titanates (such as lanthanum titanate), calcium acetate/antimony trioxide mixtures, lithium and magnesium alkoxides, stannous catalysts, and mixtures of two or more thereof.

The copolyetheresters useful in the compositions disclosed herein can also be obtained commercially from E.I. du Pont de Nemours and Company (U.S.A.) (hereafter “DuPont”) under the trade name Hytrel®.

Based on the total weight of components (a), (b), (c) and (d) of the fire-retardant copolyetherester composition disclosed herein, the at least one copolyetherester of component (a) may be present at a level of about 45-90 wt. %, or about 50-80 wt. %, or about 55-70 wt. %.

Halogen-free flame retardants suitable for use in the compositions disclosed herein may be selected from phosphinates of the formula (I), diphosphinates of the formula (II), and combinations or polymers thereof

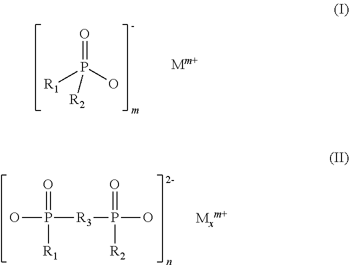

wherein R₁ and R₂ may be identical or different and each of R₁ and R₂ is hydrogen, a linear, branched, or cyclic C₁-C₆ alkyl group, or a C₆-C₁₀ aryl group; R₃ is a linear or branched C₁-C₁₀ alkylene group, a C₆-C₁₀ arylene group, a C₆-C₁₂ alkyl-arylene group, or a C₆-C₁₂ aryl-alkylene group; M is selected from calcium ions, aluminum ions, magnesium ions, zinc ions, antimony ions, tin ions, germanium ions, titanium ions, iron ions, zirconium ions, cerium ions, bismuth ions, strontium ions, manganese ions, lithium ions, sodium ions, potassium ions and combinations thereof; each of m, n, and x is independently an integer of 1-4. Preferably, R₁ and R₂ may be independently selected from hydrogen, methyl, ethyl, n-propyl, isopropyl, n-butyl, tert-butyl, n-pentyl, and phenyl; R₃ may be selected from methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene, and phenylbutylene; and M may be selected from aluminum and zinc ions. More preferably, the phosphinates used here may be selected from aluminum methylethylphosphinate, aluminum diethylphosphinate, and combinations thereof.

The halogen-free flame retardants useful herein may also be obtained commercially from Clariant (Switzerland) under the trade name Exolit™ OP.

Based on the total weight of component (a), (b), (c) and (d) of the fire-retardant copolyetherester composition disclosed herein, the at least one halogen-free flame retardant, i.e. component (b), may be present at a level of about 5-30 wt. %, or about 7.5-25 wt. %, or about 10-25 wt. %.

The nitrogen containing compounds suitable for use in the fire-retardant copolyetherester compositions disclosed herein may include, without limitation, those described, for example in U.S. Pat. Nos. 6,365,071; and 7,255,814.

In one embodiment, the nitrogen containing compounds used herein are selected from melamine, benzoguanamine, tris(hydroxyethyl)isocyanurate, allantoine, glycouril, dicyandiamide, guanidine and carbodiimide, and derivatives thereof.

In a further embodiment, the nitrogen containing compounds used herein may be selected from melamine derivatives, which include, without limitation, (i) melamine cyanurate, (ii) condensation products of melamine, (iii) reaction products of phosphoric acid with melamine, and (iv) reaction products of phosphoric acid with condensation products of melamine. Suitable condensation products may include, without limitation, melem, melam and melon, as well as higher derivatives and mixtures thereof. Condensation products of melamine can be produced by any suitable methods (e.g., those described in PCT Patent Publication No. WO9616948). Reaction products of phosphoric acid with melamine or reaction products of phosphoric acid with condensation products of melamine are herein understood to be compounds which result from the reaction of melamine with a phosphoric acid or the reaction of a condensation product of melamine (e.g., melem, melam, or melon) with a phosphoric acid. Examples include, without limitation, dimelamine phosphate, dimelamine pyrophosphate, melamine phosphate, melamine polyphosphate, melamine pyrophosphate, melamine polyphosphate, melam polyphosphate, melon polyphosphate, and melem polyphosphate, as are described, e.g., in PCT Patent Publication No. WO9839306.

In one embodiment, the at least one nitrogen containing compound comprised in the composition disclosed herein is a melamine phosphate.

In another embodiment, the at least one nitrogen containing compound comprised in the composition disclosed herein is a melamine polyphosphate.

Based on the total weight of components (a), (b), (c), and (d) of the fire-retardant copolyetherester composition disclosed herein, the at least one nitrogen containing compound, i.e. component (c), may be present at a level of about 0.1-20 wt. %, or about 1-15 wt. %, or about 2-15 wt. %.

Molybdenum oxides that may be comprised in the fire-retardant copolyetherester compositions disclosed herein may be selected from molybdenum (IV) oxide, molybdenum (V) oxide, molybdenum (VI) oxide, and combinations of two or more thereof. The molybdenum oxides useful herein may also be obtained commercially from Climax Molybdenum Company (U.S.A.).

Based on the total weight of components (a), (b), (c), and (d) of the fire-retardant copolyetherester composition disclosed herein, the at least one molybdenum oxide, i.e. component (d), may be present at a level of about 0.1-5 wt. %, or about 0.1-4 wt. %, or about 0.1-3 wt. %.

The fire-retardant copolyetherester composition disclosed herein may further comprise other additives, such as colorants, antioxidants, UV stabilizers, UV absorbers, heat stabilizers, lubricants, tougheners, impact modifiers, reinforcing agents, viscosity modifiers, nucleating agents, plasticizers, mold release agents, scratch and mar modifiers, impact modifiers, emulsifiers, pigments, optical brighteners, antistatic agents, fillers, and combinations of two or more thereof. Suitable fillers may be selected from calcium carbonates, silicates, talcum, carbon black, and combinations of two or more thereof. Based on the total weigh of the composition disclosed herein, such additional additive(s) may be present at a level of about 0.01-20 wt. % or about 0.01-10 wt. %, or about 0.2-5 wt. %, or about 0.5-2 wt. %.

Based on the total weight of components (a), (b), (c), and (d) of the composition disclosed herein, the component (a) at least one copolyetherester, the component (b) at least one halogen-free flame retardant, the component (c) at least one nitrogen containing compound, and the component (d) at least one molybdenum oxide may be present in amounts of,
about 45-94.89 wt. %, about 5-30 wt. %, about 0.1-20 wt. %, and about 0.01-5 wt. %, respectively; or
about 56-91.4 wt. %, about 7.5-25 wt. %, about 1-15 wt. %, and about 0.1-4 wt. %, respectively; or
about 57-87.9 wt. %, about 10-25 wt. %, about 2-15 wt. %, and about 0.1-3 wt. %, respectively.

The copolyetherester compositions disclosed herein are melt-mixed blends, wherein all of the polymeric components are well-dispersed within each other and all of the non-polymeric ingredients are homogeneously dispersed in and bound by the polymer matrix, such that the blend forms a unified whole. Any melt-mixing method may be used to combine the polymeric components and non-polymeric ingredients of the composition disclosed herein.

As demonstrated by the examples presented below, when compared to prior art fire-retardant copolyetheresters, e.g. (CE1), wherein zinc borate is used as the flame retardant synergist, the fire-retardant copolyetherester compositions disclosed herein (E1 and E2), which comprise molybdenum oxides as the flame retardant synergist, possess improved thermal stability while maintaining low flammability.

Further disclosed herein are articles comprising one or more component parts formed of the fire-retardant copolyetherester compositions disclosed herein, wherein the articles include, without limitation, motorized vehicles, electrical/electronic devices, furniture, footwear, roof structure, outdoor apparels, water management system, etc.

In one embodiment, the articles are selected from motorized vehicles. In such embodiments, the fire-retardant copolyetherester compositions disclosed herein may be used to form component parts such as airducts, constant velocity joints (CVJ) boots, etc.

In a further embodiment, the articles are selected from electrical/electronic devices. In such embodiments, the fire-retardant copolyetherester compositions disclosed herein may be used to form insulating layers or jacket for wire and cable. More particularly, the articles may be selected from wires and cables, which comprise insulating layers and/or jackets formed of the fire-retardant copolyetherester compositions disclosed herein. For example, the article may be an insulated wire or cable, which comprises two or three electrically conductive cores, two or three insulating layers each surrounding one of the electrically conductive cores, and optionally an insulating jacket surrounding the electrically conductive cores and the insulating layers, wherein the insulating layers and/or the insulating jacket are formed of the fire-retardant copolyetherester composition disclosed herein.

### EXAMPLES

### Material

Copolyetherester: copolyetherester elastomer obtained from DuPont under the trade name Hytrel®3078;
AO: antioxidant concentrate obtained from DuPont under the trade name Hytrel®30HS;
FR: an aluminum diethylphosphinate based halogen-free flame retardant obtained from Clariant International Ltd. (Switzerland) under the trade name Exolit™ OP1230;
MPP: melamine polyphosphate obtained from Hangzhou JLS Flame Retardants Chemical Co., Ltd (China);
ZB: zinc borate obtained from US Borax (U.S.A.) under the trade name Firebrake™ZB;
MO: molybdenum (VI) oxide obtained from Climax Molybdenum Company (U.S.A.).

### Comparative Example CE1 and Examples E1-E3

In each of Comparative Example CE1 and Examples E1-E3, a copolyetherester composition composed of the components listed in Table 1 was prepared as follows: appropriate amounts of copolyetherester, AO, FR, and ZB or MO were dried, pre-mixed, and melt blended in a ZSK26 twin-screw extruder (Coperion Werner & Pfleiderer GmbH & Co. (Germany)) with the extruder temperature set at 190-210° C., the extrusion speed at 300 rpm, and the throughput at 20 kg/hr. In each example, insulated conducting wires were prepared, wherein each of the insulated conducting wires had a circular cross section and a diameter of about 2 mm, and wherein each of the insulated conducting wires had an insulating jacket made of the copolyetherester composition and encircling conductive core that was made of 91 stranded copper wires. In accordance with UL1581, the flammability (VW-1), tensile strength, and ultimate elongation of the insulated conducting wires were measured. Results are tabulated in Table 1 below. Also, the insulated conducting wires were further aged for 168 hours at 121° C. or 136° C. in ovens and the tensile strength and the ultimate elongation thereof after aging were measured and are tabulated in Table 1 below.

As is illustrated by CE1, wherein zinc borate was added as a flame retardant synergist, the insulated conducting wires made therefrom had a tensile strength of 10.54 MPa and an ultimate elongation of 652.68% prior to aging. However, the tensile strength and the ultimate elongation thereof were too low for measurement after the insulated conducting wires had been aged for 168 hours at 121° C. or 136° C. In comparison, E1-E3, wherein molybdenum oxides were added in place of zinc borate to the copolyetherester composition, the retention of tensile strength and the retention of ultimate elongation after the insulated conducting wires had been aged for 168 hours at 121° C. were >81% and >74%, respectively, and the retention of tensile strength and the retention of ultimate elongation after the insulated conducting wires had been aged for 168 hours at 136° C. were >65% and >46%, respectively.

TABLE 1

| | CE1 | E1 | E2 | E3 |
|---|---|---|---|---|
| Copolyetherester | 64.5 | 65.5 | 65 | 64 |
| AO | 4 | 4 | 4 | 4 |
| FR | 20 | 20 | 20 | 20 |
| MPP | 10 | 10 | 10 | 10 |
| ZB | 1.5 | | | |
| MO | | 0.5 | 1 | 2 |

Properties

| | | | | |
|---|---|---|---|---|
| Flammability (VW-1) | Pass | Pass | Pass | Pass |
| Tensile strength (MPa) | 10.54 | 15.79 | 16.25 | 14.72 |
| Ultimate elongation (%) | 652.68 | 802.3 | 782.72 | 808.36 |

Post 121° C. and 168 hours aging

| | | | | |
|---|---|---|---|---|
| Tensile strength (MPa) | ND* | 13.22 | 13.93 | 12.01 |
| Retention of Tensile strength (%) | — | 83.72 | 85.72 | 81.59 |
| Ultimate elongation (%) | ND* | 618.91 | 640.49 | 598.37 |
| Retention of Ultimate elongation | — | 77.14 | 81.83 | 74.02 |
| (%) | | | | |

Post 136° C. and 168 hours aging

| | | | | |
|---|---|---|---|---|
| Tensile strength (MPa) | ND* | 10.7 | 11.04 | 9.67 |
| Retention of Tensile strength (%) | — | 67.76 | 67.94 | 65.69 |
| Ultimate elongation (%) | ND* | 477.98 | 425.5 | 378.44 |
| Retention of Ultimate elongation | — | 59.58 | 54.36 | 46.82 |
| (%) | | | | |

ND*: too low for measurement.

What is claimed is:

1. A fire-retardant copolyetherester composition having improved thermal stability, which comprises:
(a) 45-94.89 wt. % at least one copolyetherester;
(b) 5-30 wt. % of at least one halogen-free flame retardant;
(c) 0.1-20 wt. % of at least one nitrogen-containing compound; and
(d) 0.01-5 wt. % of at least one molybdenum oxide,
wherein the weight percentages are based on the total weight of (a) plus (b) plus (c) plus (d) and the at least one halogen-free flame retardant comprises at least one selected from the group consisting of phosphinates of the formula (I), diphosphinates of the formula (II), and combinations or polymers thereof 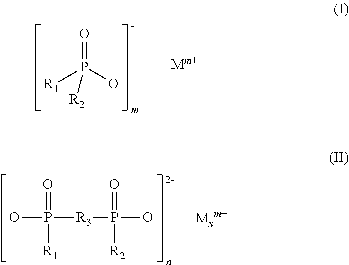
wherein R₁ and R₂ are identical or different and each of R₁ and R₂ is hydrogen; a linear, branched, or cyclic C₁-C₆ alkyl group; or a C₆-C₁₀ aryl group; R₃ is a linear or branched C₁-C₁₀ alkylene group, a C₆-C₁₀ arylene group, a C₆-C₁₂ alkyl-arylene group, or a C₆-C₁₂ aryl-alkylene group; M is selected from calcium ions, aluminum ions, magnesium ions, zinc ions, antimony ions, tin ions, germanium ions, titanium ions, iron ions, zirconium ions, cerium ions, bismuth ions, strontium ions, manganese ions, lithium ions, sodium ions, potassium ions and combinations thereof; and m, n, and x each is independently an integer of 1-4.

2. The fire-retardant copolyetherester composition of claim 1, wherein the at least one molybdenum oxide is selected from the group consisting of molybdenum (IV) oxide, molybdenum (V) oxide, molybdenum (VI) oxide, and combinations thereof.

3. The fire-retardant copolyesterester composition of claim 2 wherein the at least one molybdenum oxide is molybdenum (VI) oxide.

4. The fire-retardant copolyetherester composition of claim 1, wherein the at least one halogen-free flame retardant is aluminum diethylphosphinate.

5. The fire-retardant copolyetherester composition of claim 1, wherein the at least one nitrogen-containing compound is selected from the group consisting of (i) melamine cyanurate, (ii) condensation products of melamine, (iii) reaction products of phosphoric acid with melamine, and (iv) reaction products of phosphoric acid with condensation products of melamine.

6. The fire-retardant copolyesterester composition of claim 1 wherein the at least one nitrogen-containing compound is a reaction product of phosphoric acid with melamine.

7. The fire-retardant copolyetherester composition of claim 6, wherein the reaction product of phosphoric acid with melamine is melamine polyphosphate.

8. The fire-retardant copolyetherester composition of claim 1, which comprises,
(a) 56-91.4 wt. % of the at least one copolyetherester;
(b) 7.5-25 wt. % of the at least one halogen-free flame retardant;
(c) 1-15 wt. % of the at least one nitrogen-containing compound; and
(d) 0.1-4 wt. % of the at least one molybdenum oxide;
the weight percentages being based on the total weight of (a) plus (b) plus (c) plus (d).

9. The fire-retardant copolyetherester composition of claim 8, which comprises,
(a) 57-87.9 wt. % of the at least one copolyetherester;
(b) 10-25 wt. % of the at least one halogen-free flame retardant;
(c) 2-15 wt. % of the at least one nitrogen-containing compound; and
(d) 0.1-3 wt. % of the at least one molybdenum oxide;
the weight percentages being based on the total weight of (a) plus (b) plus (c) plus (d).

10. An article comprising at least one component part formed of the fire-retardant copolyetherester composition of claim 1.

11. The article of claim 10, wherein the article is selected from motorized vehicle parts and electrical/electronic devices.

12. The article of claim 10, wherein the article is selected from insulated wires and cables.

13. The article of claim 12, wherein the insulated wires and cables comprise one or more insulating layers and/or insulating jackets that are formed of the fire-retardant copolyetherester composition of any of claim 1.
